(19) United States
(12) Patent Application Publication
(10) Pub. No.: US 2010/0175974 A1
(43) Pub. Date: Jul. 15, 2010

(54) LOW PROFILE MULTI-DIRECTIONAL KEY UNIT STRUCTURE

(75) Inventors: Shin-Yuan Huang, Taoyuan Hsien (TW); Chien-Yu Hsu, Taoyuan Hsien (TW)

Correspondence Address: BRIAN M. MCINNIS, 12th Floor, Ruttonjee House, 11 Duddell Street, Hong Kong, HK

(73) Assignee: SPEED TECH CORP., TAOYUAN HSIEN (TW)

(21) Appl. No.: 12/472,376

(22) Filed: May 27, 2009

(30) Foreign Application Priority Data
Jan. 12, 2009 (TW) 98200546

(51) Int. Cl. H01H 13/50

(52) U.S. Cl. 200/344

(57) ABSTRACT

A low profile multi-directional key unit structure is provided, especially for allowing a user to generate various instructions by pushing one single key unit. The key unit structure comprises a magnetic element, a key cap and an elastic member. The magnetic element is fixed to the key cap, and the elastic member is fixed to the key cap, and thereby the movement of the key cap is restricted by the elastic member. The elastic member is a helical spring structure with progressively increasing outwards in diameter from its central area.

### RELATED APPLICATIONS

This application claims priority to Taiwan Utility Patent Application Serial Number 98200546, filed Jan. 12, 2009, which is herein incorporated by reference.

### BACKGROUND

1. Field of Invention

The present invention relates to a low profile multi-directional key unit structure. More particularly, the present invention relates to a multi-directional key unit suitable for use in a mobile communication device, and allowing a user to generate various instructions by pushing one single key unit.

2. Description of Related Art

A multi-directional key is a very popular key that is often used in automobiles, mobile phones, notebook computers, audio players and other home appliances. The multi-directional key is generally used to navigate a cursor shown on a screen, and functions like a computer mouse or trace ball.

U.S. Pat. No. 7,348,512 disclosed a multi-directional key used in a mobile phone, and was mainly to install a plurality of dome switches under a key cap. When a user presses the key cap corresponding to a certain direction, a dome switch nearest the pressed point is operated to generate a signal, and the system will make a response in accordance with the signal.

As shown in FIG. 13, U.S. Patent Publication No. 20080048649 disclosed a thin input device and a mobile terminal equipped with the thin input device, which was mainly a combination of housing A, a key cap B, a magnetic element C, an elastic element D and a displacement detection means F. The combination as a whole is removably and directly fixed on a circuit board G of the mobile terminal. The key cap B is capable of being displaced in any direction, and the magnetic element C is disposed in the key cap B. The displacement detection means F is electrically connected to an external electronic device, and contains a plurality of Hall sensors which are used for detecting the displacement of the key cap B. The housing A is removably fixed on a circuit board of the external electronic device, and removably covers the lo key cap B. The elastic element D is disposed between the circuit board G and the key cap B, and meanwhile, is substantially fixed on the circuit board G via the housing A. The elastic element D is made of a flexible and elastic material, and thus is deformed whenever the key cap B is displaced, thereby generating a recovery force intending to push the key cap B back to the original position.

In the U.S. Patent Publication No. 20080048649, when the key cap B is displaced in any direction, the magnetic element C is also displaced with the key cap B. Once the magnetic element C is displaced, a magnetic field change occurs around the magnetic element C, and the displacement detection means F may detect the magnetic field change promptly and send the information regarding the magnetic field change to a circuit on the circuit board G, so that the mobile terminal system may make a proper response to the displacement of the key cap B.

Since the elastic element D is formed from a flexible and elastic material, the elastic element D itself has a downward weight force, and meanwhile, the weights of the key cap B and the magnetic element C also keep pressing on the elastic element D. These weights together exerts a preload pressure on a dome switch G1 on the circuit board G, and thus the dome switch G1 on the circuit board G will be likely triggered easily by accident and issue a false message to the circuit board G. Hence, the design of U.S. Patent Publication No. 20080048649 fails to meet actual industrial requirements.

### SUMMARY

On aspect of the present invention is to provide a low profile multi-directional key unit structure for lowering the chance of falsely trigging the dome switch.

According to one embodiment, a low profile multi-directional key unit structure comprises a magnetic element, a key cap and an elastic member, wherein a portion of the magnetic element is fixed to the key cap, and the elastic member surrounds the magnetic element so that the movement of key cap is restricted by the elastic member, and the elastic member has at least one involute helical structure with progressively increasing outwards in diameter from its central area, and the center of figure of the elastic member is positioned adjacent to the key cap.

The elastic member is a helical structure shows a close approximation of involute curves extending outwards from its central area, i.e., the elastic member is not solid body but has hollow regions. Since the elastic member of the present invention is a helical structure having hollow regions, the weight at a central region of the elastic member is reduced, so that less preload pressure is exerted on the dome switches of a conventional circuit board, thus lowering the chance of accidentally triggering the dome switches of the circuit board.

In the structure of the present invention, although, just as the conventional structure, the weights of the key cap and the magnetic element also are consistently exerted on the elastic member, yet the present invention merely needs to adjust the degree of tightness of the involute curves of the helical structure or to change the cross-sectional shape or dimensions of the helical structure, so as to make the helical structure of the elastic member effectively support the weights of the key cap and the magnetic element.

Since the elastic recovery force of the elastic member rebounds the key cab back to an original position after the key cab is pushed and displaced from the original position by a user, the movement of the key cap cannot be deviated too far from an elastic center of the elastic member. With respect to an elastic member commonly adopting a helical structure to provide elastic force, an elastic center of the helical structure is generally close to a center of figure of the helical structure, and thus the key cap of the present invention has to be constantly kept closed to the center of figure of the helical structure, so as to utilize the elastic force of the helical structure to return back to the proper position.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is a schematic 3-D diagram showing a first embodiment of the present invention;

FIG. 2 is a schematic side view of the first embodiment;

FIG. 3 is a schematic explosive view of the first embodiment;

FIG. 4 is a schematic top view of the first embodiment;

FIG. 5 is a schematic cross-sectional diagram viewed along line A-A in FIG. 4;

FIG. 6 is a schematic 3-D diagram showing a second embodiment of the present invention;

FIG. 7 is a schematic cross-sectional diagram viewed along line A′-A′ in FIG. 6;

FIG. 8 is a schematic 3-D diagram showing a third embodiment of the present invention;

FIG. 9 is a schematic 3-D diagram showing a housing of the third embodiment from another view angle;

FIG. 10 is a schematic explosive view of the third embodiment;

FIG. 11 is a schematic top view of the third embodiment;

FIG. 12 is a schematic cross-sectional diagram viewed along line B-B in FIG. 12; and

FIG. 13 is a schematic explosive view showing a thin input device of U.S. Patent Publication No. 20080048649.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

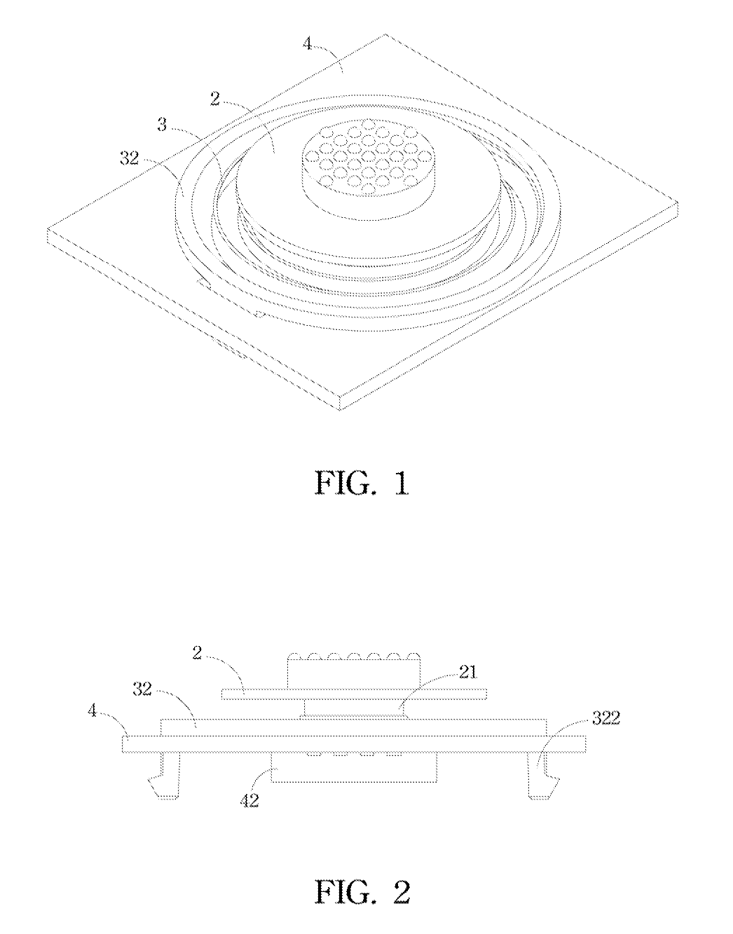

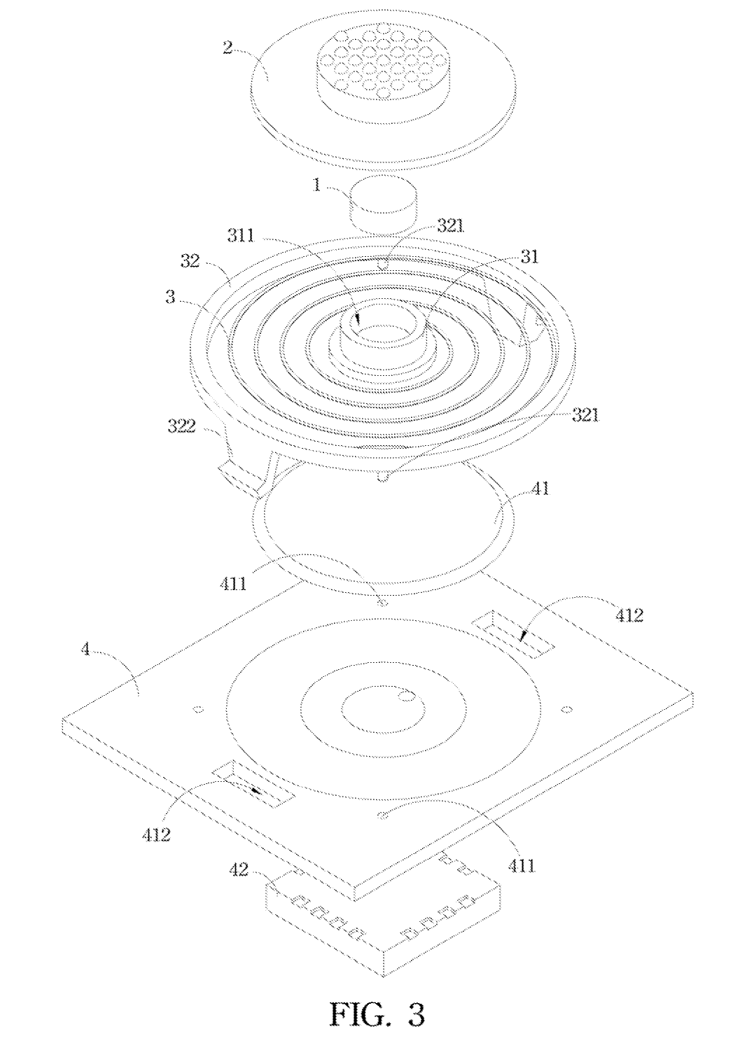

As shown in FIG. 1, FIG. 2, FIG. 3 and FIG. 4, the first embodiment of the present invention, a low profile multi-directional key unit structure is mounted on a circuit board 4 of an electronic device, and there is a dome switch 41 mounted on a surface of the circuit board 4, and a magnetic sensor 42 mounted on the opposed surface of the circuit board 4, the magnetic sensor 42 containing a plurality of Hall sensors.

In the first embodiment, a low profile multi-directional key unit structure comprises a magnetic element 1, a key cap 2 and an elastic member 3. A portion of the magnetic element 1 is fixed to the key cap 2, and another portion of the magnetic element 1 is fixed to a central area of the elastic member 3. The elastic member 3 surrounds the magnetic element 1, so that the movement of key cap 2 is restricted by the elastic member 3, and the elastic member 3 has a helical structure with progressively increasing outwards in diameter from its central area.

In the first embodiment, the key cap 2 has an annular flange 21 extending towards the circuit board 4 from its central area, and holding the magnetic element 1 onto the key cap 2. The elastic member 3 has a holder 31 formed at its center of figure, and a restriction ring 32 disposed at an outer edge of the elastic member 3. The holder 31 of the elastic member 3 has an accommodation recess 311 for receiving at least a portion of the magnetic element 1. In the first embodiment, the accommodation recess 311 receives the magnetic element 1 and the annular flange 21 of the key cap 2, thereby fixing the relative positions among the magnetic element 1, the key cap 2 and the holder 31 of the elastic member 3. Since the elastic member 3 has a helical structure with progressively increasing in diameter from the holder 31 towards the restriction ring 32 and is not a solid structure, the weight of the elastic member 3 can be reduced due to hollow regions existing therein.

The restriction ring 32 at the outer edge of the elastic member 3 has a plurality of positioning pins 321 disposed corresponding to positioning holes 411 on the circuit board 4. By using the positioning pins 321 fitting into correspondingly positioning holes 411 on the circuit board 4, the elastic member 3 is accurately positioned on the circuit board 4. In the first embodiment, the restriction ring 32 further has a pair of locking hooks 322 disposed corresponding to the through holes 412, and thus the locking hooks 322 can be inserted through the through holes 412 to position and clip the restriction ring 32 on the circuit board 4.

When the low profile multi-directional key unit structure of the first embodiment is mounted on the circuit board 4 of the electronic device, and a user pushes the key cap 2 to generate a planar displacement parallel to the circuit board 4, the magnetic element 1 moves together with the key cap 2, and meanwhile, the helical structure of the elastic member 3 is elastically deformed to restore energy to generate a counter-elastic force correspondingly. Once the pushing force is removed, the energy restored in the helical structure of the elastic member 3 is released to push the magnetic element 1 back to the original position. Similarly, when the user pushes the key cap 2 to generate a vertical displacement relative to the circuit board 4, the helical structure of the elastic member 3 will be elastically deformed to restore a counter-elastic force correspondingly. Once the user's push force is removed, the helical structure of the elastic member 3 will push the magnetic element 1 back to its original position.

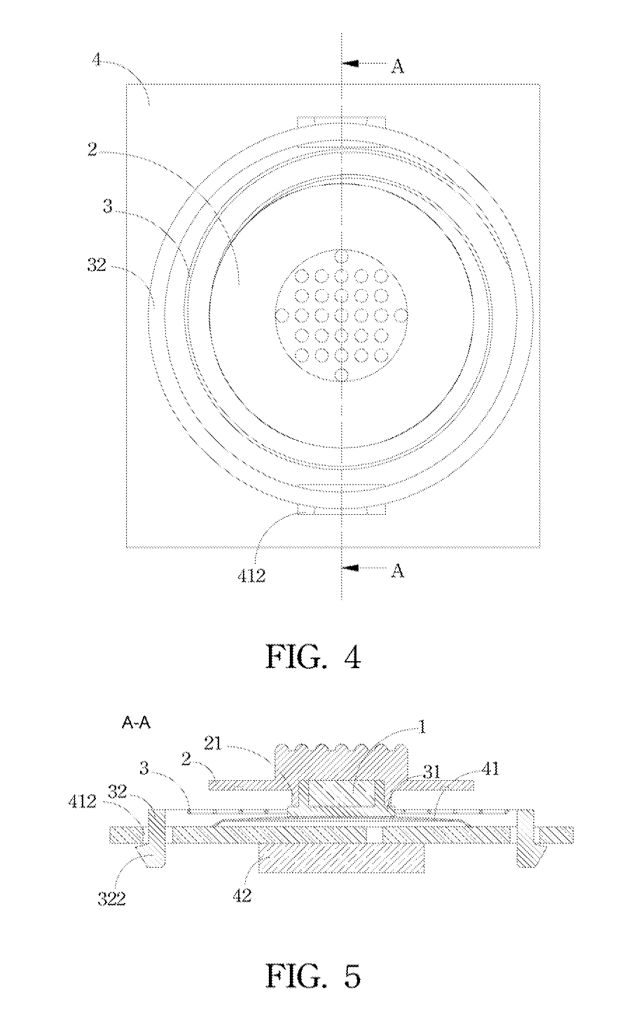

In the first embodiment, although the magnetic element is first installed in the holder 31 of the elastic member 3 and then is mounted within the annular flange 22 of the key cap 2, yet a portion of the magnetic element 1 is mounted within the annular flange 22 of the key cap 2 in the cross-sectional relationship as shown in FIG. 5.

In the first embodiment, the elastic member 3, the holder 31 and the restriction ring 32 can be formed by an injection forming process using an elastic-plastic material with good electrical insulating properties, and thus the elastic recovery force of the elastic member 3 in the planar direction can be adjusted by fine tuning the degree of tightness of the involute curves of the helical structure of the elastic member 3. When the recovery force of the elastic member 3 in the vertical direction needs to be fine tuned, it can be adjusted by changing the cross-sectional shape or dimensions of the helical structure of the elastic member 3.

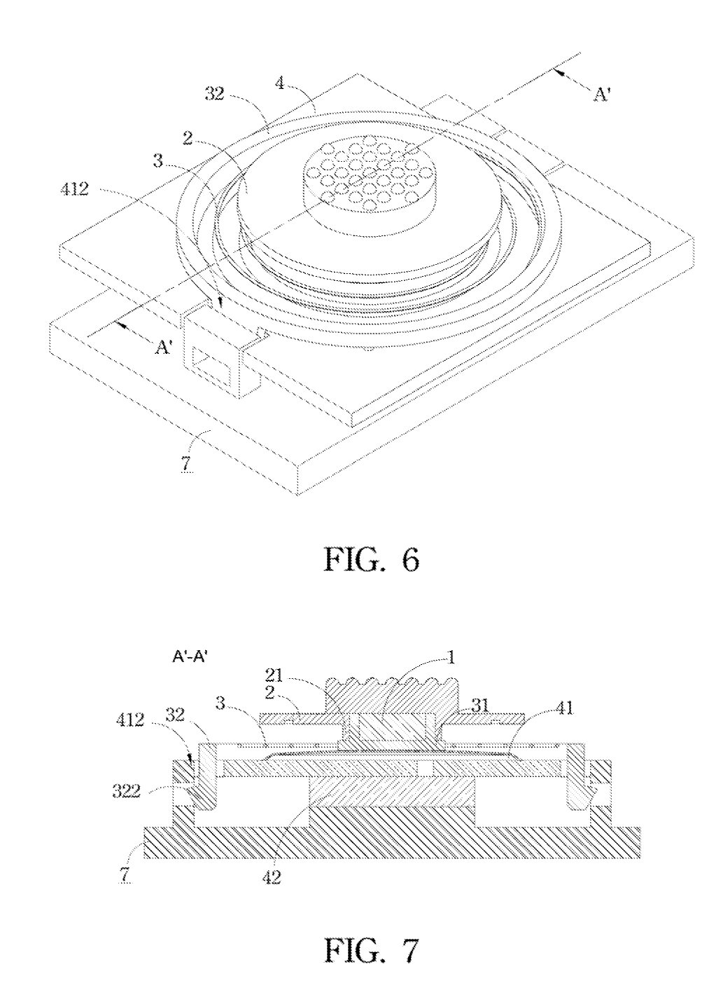

As shown in FIG. 6 and FIG. 7, the second embodiment, the through holes 412 disposed on the circuit board 4 of the electronic device is an opening allowing the locking hooks 322 on the restriction ring 32 to pass through the electric board 4 to clip on another position of the electronic device, such as a casing 7 of the electronic device.

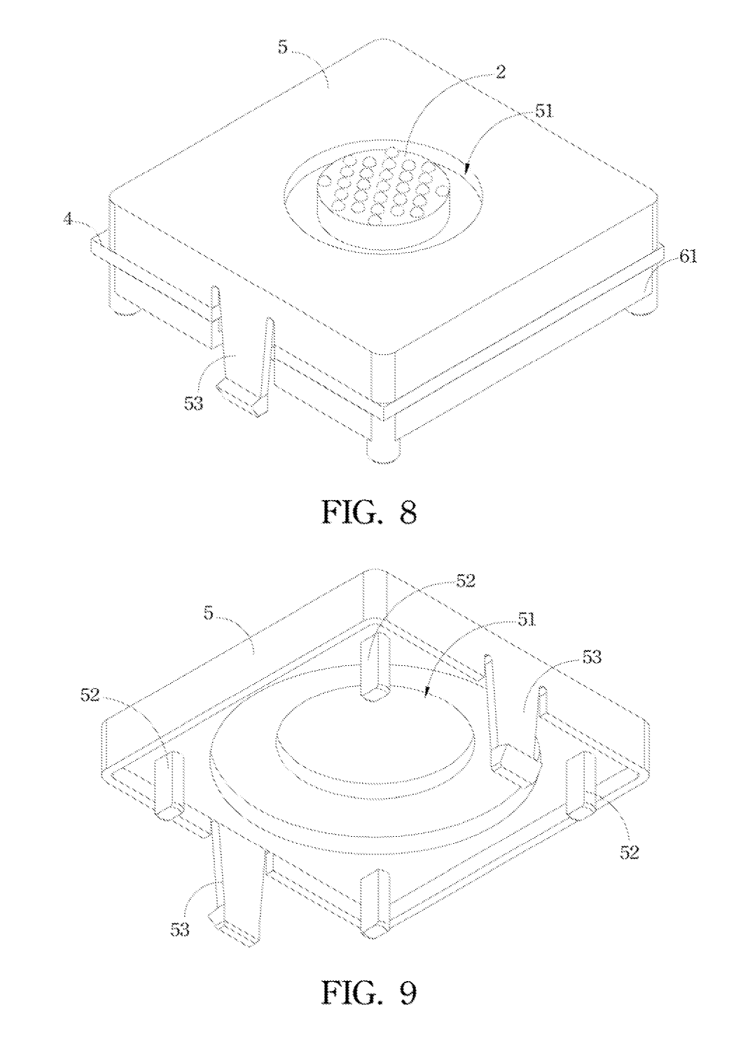

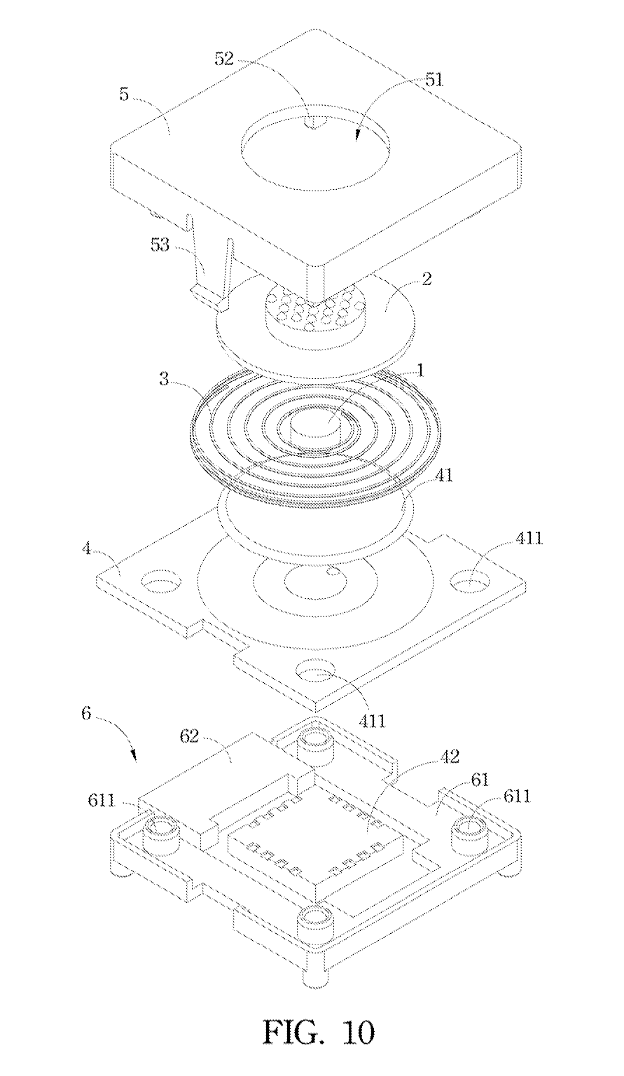

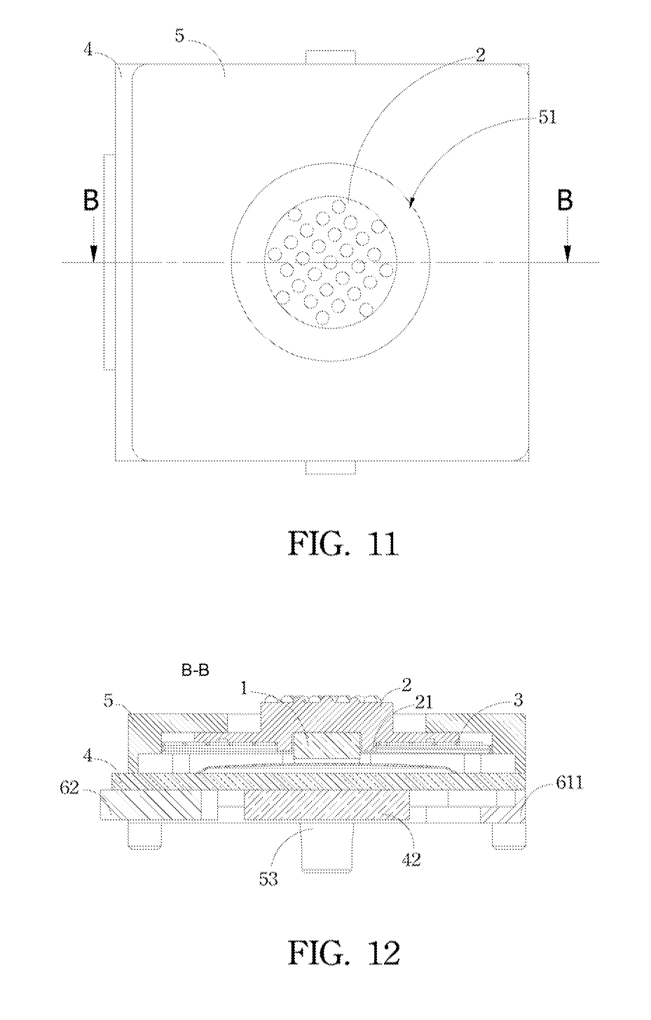

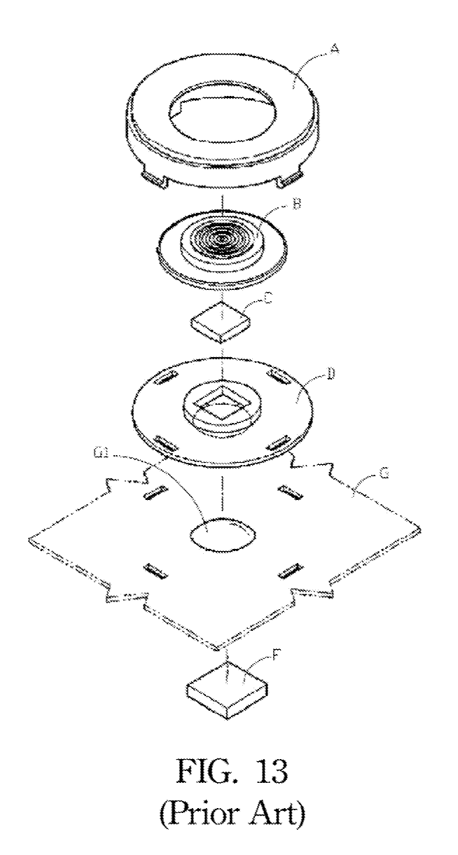

As shown in FIG. 8, FIG. 9, FIG. 10, FIG. 11 and FIG. 12, the third embodiment, the helical structure of the elastic member 3 is a typical helical spring, and thus the elastic member 3 has hollow regions.

In the third embodiment, the key cap 2 has the annular flange 21 extending towards the circuit board 4 for receiving the magnetic element 1, and the elastic member 3 is sleeved on an outer edge of the annular flange 21, and thus the relative positions among the magnetic element 3, the key cap 2 and the elastic member 3 can be defined.

In the third embodiment, the multi-directional key unit structure further has a housing 5 and a base 6, and the housing 5 has a through hole 51 located at its central area for allowing the key cap 2 to pass through loosely, and the housing 5 substantially covers the key cap 2 and the elastic member 3.

Since the elastic member 3 of the third embodiment is not implemented with the restriction ring 32 of the first embodiment, a plurality of positioning pins 52 are disposed on the housing 5 of the third embodiment, so that the key cap 2, the elastic member 3 and the housing 5 of the multi-directional key unit can be positioned on the circuit board 4 by using the positioning pins 52 fitting into positioning hole of the circuit board 4. Meanwhile, a pair of locking hooks 53 is disposed on the housing 5 of the third embodiment for fixing the housing 5 on the circuit board 4 or on a casing of an electronic device. The structure of the housing 5 of the third embodiment is simple, and thus can be a display panel disposed on the casing of the electronic device.

In the third embodiment, the base 6 has a frame 61 used for installing the multi-directional structure at a proper position in the electronic device, such as the casing. Further, in the third embodiment, the base 6 has a connector 62, so that the circuits on the circuit board 4 can be simplified by using the connector 62 to electrically connect with the circuits on the circuit board 4 to other circuits, thereby modulizing the entire multi-directional key unit structure.

In the third embodiment, there are a plurality of guide holes 611 disposed on the frame 61 of the base 6 corresponding to the respective positioning holes 411 of the circuit board 4, and thus the positioning pins 52 of the housing 5 can be simultaneously fit tightly into the positioning holes 411 and the guide holes 611, thereby easily completing the overall assembly of the multi-directional key unit structure.

In comparison with the first embodiment and the third embodiment, it can be known that the holder 31 and the restriction ring 32 in the first embodiment have auxiliary efficacy in assisting the assembly of the elastic member 3. However, those who are skilled in the art may not need the holder 31 and the restriction ring 32 to enable the present invention. Similarly, in the first embodiment, the elastic member 3, the holder 31 and the restriction ring 32 are formed by an injection forming process with respect to their mechanical structures. However, in an actual application of the present invention, the key cap 2 can be formed with the elastic member 3 without the holder 31 formed. In the first embodiment, the key cap 2 is not combined with the elastic member 3 and the holder 31 until assembly begins. However, in the aforementioned monolithically-formed key cap 2 and elastic member 3, the key cap 2 can be used to directly fix to the elastic member 3, which should be easily learned from the present invention by those who are skilled in the art.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A low profile multi-directional key unit structure, comprising:
a key cap;
a magnetic element, wherein at least one portion of the magnetic element is mounted in the key cap;
an elastic member having a helical structure with progressively increasing outwards in diameter from its central area, wherein a center of figure of the elastic member is positioned adjacent to the key cap, and movements of the key cap and the magnetic element are restricted by the elastic member.

2. The low profile multi-directional key unit structure as claimed in claim 1, further comprising:
a restriction ring disposed at an outer edge of the helical structure of the elastic member, wherein the elastic member is positioned by collaborating with the restriction ring.

3. The low profile multi-directional key unit structure as claimed in claim 1, wherein the restriction ring and the helical structure of the elastic member are monolithically formed by an injection forming process using an electrical insulating material.

4. The low profile multi-directional key unit structure as claimed in claim 1, wherein the key cap and the elastic member are monolithically formed.

5. The low profile multi-directional key unit structure as claimed in claim 1, wherein the helical structure is a helical spring.
